(19) United States
(12) Patent Application Publication
(10) Pub. No.: US 2018/0167495 A1
(43) Pub. Date: Jun. 14, 2018

(54) SERVER SYSTEM

(71) Applicants: Inventec (Pudong) Technology Corp., Shanghai City (CN); Inventec Corporation, Taipei City (TW)

(72) Inventor: Xuxiang Wu, Shanghai City (CN)

(21) Appl. No.: 15/831,475

(22) Filed: Dec. 5, 2017

(30) Foreign Application Priority Data
Dec. 12, 2016 (CN) 201611137776.3

(51) Int. Cl. H04L 29/06; H04L 29/08; G06F 13/40; H04L 12/931; H04B 10/40; G06F 1/04; G06F 3/06

(52) U.S. Cl. CPC H04L 69/08; H04L 67/2823; H04L 29/06; G06F 13/4063; G06F 3/0683; H04B 10/40; G06F 1/04; G06F 3/0679; H04L 49/357

(57) ABSTRACT

The present disclosure provides a server system including a storage server and a host server. The storage server includes a storage device, a first data converting unit and a first data transmitting unit. The storage device stores the data of the server system. The first data converting unit transmits the data and converts the data as a data packet. The first data transmitting unit receives and transmits the data packet. The host server, which includes a second data transmitting unit, a second data converting unit and a processing unit, is communicatively connected to the storage server. The second data transmitting unit is correspondingly configured with the first data transmitting unit, receives and transmits the data packet. The data converting unit transmits the data and converts the data packet as the pending data. The processing unit receives the pending data, and processes and computes the pending data.

### CROSS REFERENCE TO RELATED APPLICATION

This application claims priority to Chinese Patent Application 201611137776.3, filed Dec. 12, 2016, the entire contents of which are incorporated herein by reference.

### BACKGROUND

### Technical Field

The present disclosure is related to a server technical field, and more particular to a server system.

### Related Art

In the current development of servers, the computation part and the storage part are configured to be separate and then the computation part and the storage part are connected through the high speed transmission line. The advantage for separating the computing part and the storage part is that the identical hardware resources are clustered together for easy maintenance and replacement.

In general, the technique of storage separation is that the dedicated storage master chip is connected to a mechanical disk or a solid state disk through SAS/SATA or PCIE to SAS/SATA. The dedicated storage master chip is connected to the Ethernet card chip through PCIE, converts the storage data as SFP+ module light signal, and transmits the SFP+ module light signal to the SFP+ module of the dedicated computation server. Then, SFP+ module of the dedicated computation server converts the received storage data as PCIE through the Ethernet card, and transmits it to the CPU of the computation server, so as to compute and process the storage data.

However, the data stream access and transmission of the whole storage data needs many complicated signal converting processes, the delay of the data stream and the performance overhead are quite large, such that the efficiency for separating the computation part and the storage part is very low. Therefore, the server design is still needed to improve.

### SUMMARY

A server system, which includes a storage server and a host server. The storage server includes a storage device, a first data converting unit and a first data transmitting unit. The storage device stores the data of the server system. The first data converting unit is coupled to the storage device, transmits the data and converts the data as a data packet. The data transmitting unit is coupled to the first data converting unit, receives and transmits the data packet. The host server is communicatively connected to the storage server, wherein the host server includes a second data transmitting unit, a second data converting unit and a processing unit. The second data transmitting unit is correspondingly configured with the first data transmitting unit, receives and transmits the data packet. The second data converting unit is coupled to the second data transmitting unit, transmits the data and converts the data packet as the pending data. The processing unit is coupled to the second data converting unit, receives the pending data, and processes and computes the pending data.

In order to make the aforementioned and other features of the present disclosure more comprehensible, several embodiments accompanied with figures are described in detail below.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is a structure diagram of a server system according to an embodiment.

FIG. 2 is a detailed structure diagram of a storage device according to an embodiment.

FIG. 3 is a diagram illustrating a coupling relationship of the storage unit and the corresponding connecting unit according to an embodiment.

FIG. 4 is a diagram illustrating another coupling relationship of the storage unit and the corresponding connecting unit according to an embodiment.

### DETAILED DESCRIPTION

The following description with reference to the accompanying drawings is provided to explain the disclosed embodiments. Note that in the case of no conflict, the disclosure and the features of the embodiments may be arbitrarily combined with each other.

In one embodiment, the first data converting unit obtains the data of the server system from the storage device, converts the data as the data packet, and transmits the data packet to the second data transmitting unit through the first data transmitting unit. Then, the second data converting unit obtains the data packet through the second data transmitting unit, converts the data packet as the pending data and transmits the pending data to the processing unit, such that the processing unit processes and computes the pending data, so as to complete the access of the data. Therefore, the complicated converting process of the data access and transmission may be efficiently saved, and the transmission bandwidth and transmission efficiency of the data are improved.

According to an embodiment, a server system is provided.

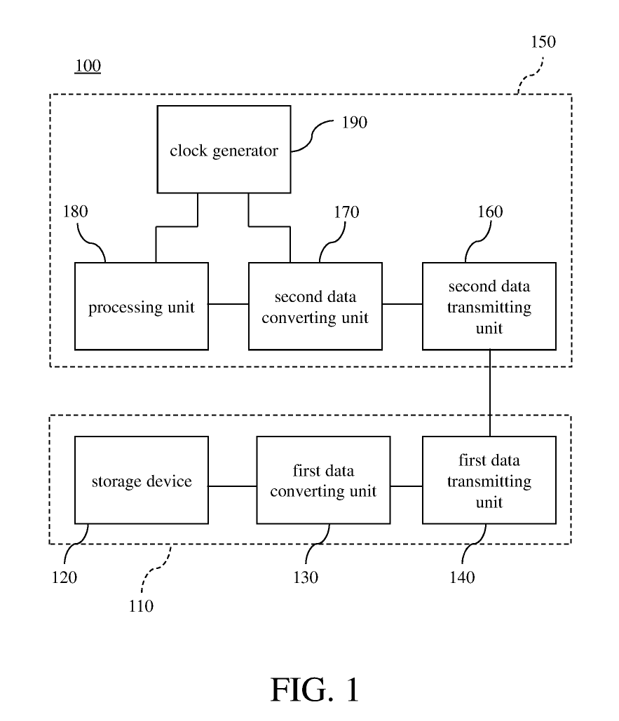

FIG. 1 is a structure diagram of a server system according to an embodiment disclosure. The server system 100 includes a storage server 110 and a host server 150. The storage server 110 includes a storage device 120, a first data converting unit 130 and a first data transmitting unit 140. The storage device 120 stores the data of the server system 100. The first data converting unit 130 is coupled to the storage device 120, transmits the data and converts the data as a data packet. The first data transmitting unit 140 is coupled to the first data converting unit 130, receives and transmits the data packet.

The host server 150 is communicatively connected to the storage server 110, wherein the host server 150 includes a second data transmitting unit 160, a second data converting unit 170 and a processing unit 180. The second data transmitting unit 160 is correspondingly configured with the first data transmitting unit 140, receives and transmits the data packet. The second data converting unit 170 is coupled to the second data transmitting unit 160, transmits the data and converts the data packet as the pending data. The processing unit 180 is coupled to the second data converting unit 170, receives the pending data, and processes and computes the pending data. Wherein the processing unit 180 is, for example, a central processing unit.

In the embodiment, the first data transmitting unit 140 and the second data transmitting unit 160 are, for example, an optical fiber transceiver respectively, and the first data transmitting unit 140 and the second data transmitting unit 160 are connected through an optical fiber. The first data converting unit 130 and the second data converting unit 170 are a PCIE optical fiber switcher respectively, wherein first data converting unit 130 converts the data transmitted by the storage device 120 and the first data transmitting unit 140, and the second data converting unit 170 converts the data transmitted between the second data transmitting unit 160 and the processing unit 180, i.e. the network protocols of the first data converting unit 130 and the second converting unit 170 are different, but the data transmitted between the first data converting unit 130 and the second converting unit 170 is the homogeneous data. That is, the first data converting unit 130 and the second data converting unit 170 uses different network protocols to convert the data as the data packet or convert the data packet as the pending data, wherein the data packet converted by the first data converting unit 130 and the data packet converted by the second data converting unit 170 are the homogeneous data.

When the host server 150 need to access the data of the storage server 110, the first data converting unit 130 obtains the data of the server system 100 from the storage device 120, converts the data as the data packet, and then transmits the data packet to the second data transmitting unit 160 through the first data transmitting unit 140. Then, the second data converting unit 170 obtains the data packet through the second data transmitting unit 160 and converts the data packet as the pending data. The second data converting unit 170 transmits the pending data to the processing unit 180, such that the processing unit 180 processes and computes the pending data, so as to complete the access of the data. Therefore, the complicated converting process needed for the data access and transmission may be efficiently saved, and the transmission bandwidth and transmission efficiency of the data are improved.

Further, the host server 150 further includes a clock generator 190. The clock generator 190 is coupled to the processing unit 180 and the second data converting unit 170, provides the clock signal needed for working to the processing unit 180 and the second data converting unit 170, so as to maintains the normal work of the processing unit 180 and the second data converting unit 170.

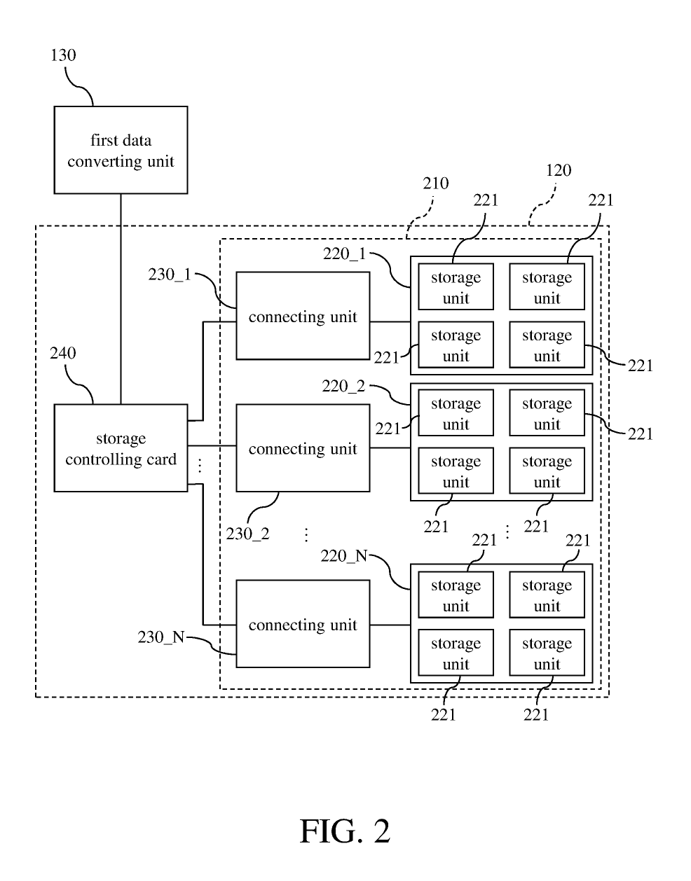

FIG. 2 is a detailed structure diagram of a storage device according to an embodiment disclosure. The storage device 120 includes a backplane 210, a plurality of storage modules 220_1˜220_N, a plurality of connecting units 230_1˜230_N and a storage controlling card 240.

The plurality of the storage modules 220_1˜220_N and the plurality of connecting units 230_1˜230_N are correspondingly configured on the backplane 210. In the embodiment, the storage modules 220_1˜220_N and the connecting units 230_1˜230_N are coupled in a one-by-one manner. For example, the storage module 220_1 and the connecting unit 230_1 are coupled, the storage module 220_2 and the connecting unit 230_2 are coupled, . . . , the storage module 220_N and the connecting unit 230_N are coupled. Each of the plurality of storage modules 220_1˜220_N are coupled to the storage controlling card 240 through the corresponding connecting units 230_1˜230_N, such that the storage controlling card 240 may control the data of the server system 100 to store to the corresponding storage modules 220_1˜220_N.

The storage controlling card 240 is coupled to the first data converting unit 130, such that the storage controlling card 240 may obtain the pending data and computed from the storage modules 220_1˜220_N, and transmit the pending data and computed to the first data converting unit 130 for performing the subsequent process.

Further, each of the plurality of storage modules 220_1˜220_N includes a plurality of storage units 221, so as to store the data of the server system 100. In the embodiment, each of the plurality of storage units 221 is a solid state disk. In the embodiment, according to the requirement of the user, the number of storage units 221 configured in each of the storage modules 220_1˜220_N allow be adjusted, i.e. the number of the storage units 221 configured in the storage modules 220_1˜220_N may be identical or different.

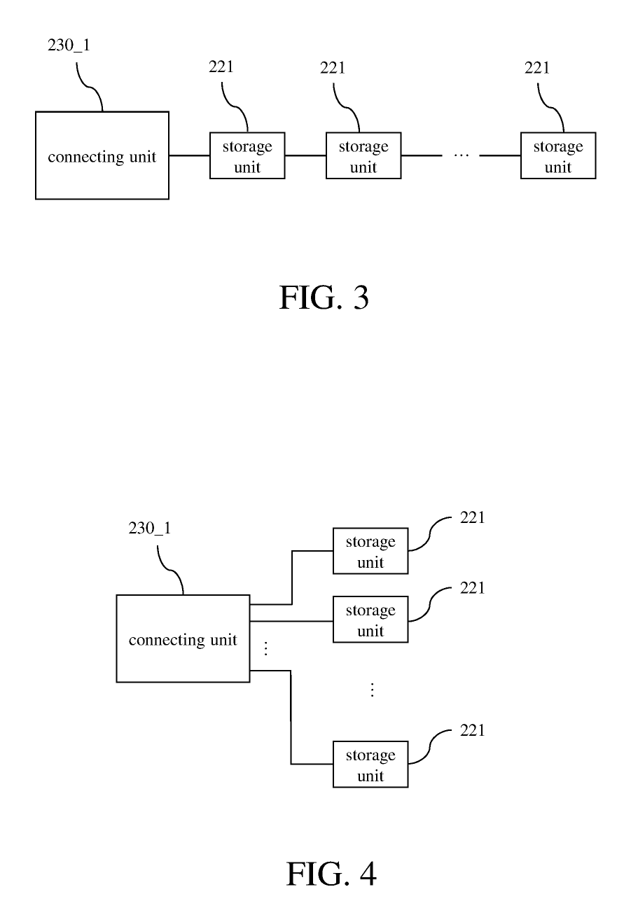

In one embodiment, the plurality of storage units 221 are coupled to the connecting unit 230_1 in a series manner, as shown in FIG. 3. That is, the storage unit 221 is coupled to the connecting unit 230_1, and the residual storage units 221 are coupled one by one in sequence and are coupled to the storage unit 221 coupled to the connecting unit 230_1. For convenience of the description, FIG. 3 only shows the coupled manner of the plurality of the storage units 221 and the connecting unit 230_1, the manner of the residual connecting units 230_2˜230_N coupled to the corresponding storage units 221 in the series manner may refer to the embodiment of the connecting unit 230_1, and the description thereof is omitted.

In another embodiment, the plurality of storage units 221 is coupled to the connecting unit 230_1 in a parallel manner, as shown in FIG. 4. That is, all of the storage units 221 are directly coupled to the connecting unit 230_1. For convenience of the description, FIG. 4 only shows the coupled manner of the plurality of the storage units 221 and the connecting unit 230 1, the manner of the residual connecting units 230_2˜230_N coupled to the corresponding storage units 221 in the parallel manner may refer to the embodiment of the connecting unit 230_1, and the description thereof is omitted.

According to the technical solution disclosure, the first data converting unit obtains the data of the server system from the storage device, converts the data as the data packet, and transmits the data packet to the second data transmitting unit through the first data transmitting unit. Then, the second data converting unit obtains the data packet through the second data transmitting unit, converts the data packet as the pending data and transmits the pending data to the processing unit, such that the processing unit processes and computes the pending data, so as to complete the access of the data. Therefore, the complicated converting process needed for the data access and transmission may be efficiently saved, and the transmission bandwidth and transmission efficiency of the data are improved.

What is claimed is:

1. A server system, comprising:
a storage server, comprising:
a storage device, storing the data of the server system;
a first data converting unit, coupled to the storage device, transmitting the data and converting the data as a data packet; and
a first data transmitting unit, coupled to the first data converting unit, receiving and transmitting the data packet; and
a host server, communicatively connected to the storage server, wherein the host server comprises:
a second data transmitting unit, correspondingly configured with the first data transmitting unit, receiving and transmitting the data packet;
a second data converting unit, coupled to the second data transmitting unit, transmitting the data and converting the data packet as the pending data; and
a processing unit, coupled to the second data converting unit, receiving the pending data, and processing and computing the pending data.

2. The server system according to claim 1, wherein the storage device comprises a backplane, a plurality of storage modules, a plurality of connecting units and a storage controlling card, the plurality of the storage modules and the plurality of connecting units are correspondingly configured on the backplane, the plurality of storage modules are coupled to the storage controlling card through the plurality of connecting units, and the storage controlling card is coupled to the first data converting unit, wherein each of the plurality of storage modules comprises a plurality of storage units.

3. The server system according to claim 2, wherein the plurality of storage units are coupled to the connecting unit in a series manner.

4. The server system according to claim 2, wherein the plurality of storage units are coupled to the connecting unit in a parallel manner.

5. The server system according to claim 2, wherein each of the plurality of storage units is a solid state disk.

6. The server system according to claim 1, wherein the host server further comprises a clock generator, and the clock generator is coupled to the processing unit and the second data converting unit.

7. The server system according to claim 1, wherein the first data transmitting unit and the second data transmitting unit are optical fiber transceivers, and the first data transmitting unit connects the second data transmitting unit through an optical fiber.

8. The server system according to claim 1, wherein the first data converting unit and the second data converting unit are PCIE optical fiber switchers, and the network protocols of the first data converting unit and the second converting unit are different.

9. The server system according to claim 1, wherein the processing unit is a central processing unit.
